(19) United States
(12) Patent Application Publication
(10) Pub. No.: US 2003/0127018 A1
(43) Pub. Date: Jul. 10, 2003

(54) Cyan dye set and ink-jet ink composition with high water-fastness

(75) Inventors: Yu-Chang Shen, Taipei (TW); In-Shan Sir, Kaohsiung (TW); Chia-Hsin Chien, Taoyuan (TW)

Correspondence Address: Richard P. Berg, Esq., c/o LADAS & PARRY, 5670 Wilshire Boulevard, Suite 2100, Los Angeles, CA, 90036-5679, US

(73) Assignee: BENO CORPORATION

(21) Appl. No.: 10/322,257

(22) Filed: Dec. 17, 2002

(30) Foreign Application Priority Data
Dec. 25, 2001 (TW) 90132239

(51) Int. Cl. C09D 11/00; C09B 1/00; C09B 47/04

(52) U.S. Cl. 106/31.27; 106/31.49; 8/638; 8/661

(57) ABSTRACT

A cyan dye set and ink-jet ink composition with high water-fastness. The cyan dye set is suitable for use in ink-jet printing and includes Acid Blue 90 dye and at least one copper phthalocyanine type blue dye. The cyan dye set has good water-fastness and exhibits improved printing quality when applied in ink-jet printing.

### BACKGROUND OF THE INVENTION

1. Field of the Invention

The present invention relates to a cyan dye set applied in ink-jet (inkjet) printing and to a cyan and color ink-jet ink composition containing the cyan dye set.

2. Background of the Invention

Generally, four kinds of ink are required for a color ink-jet printing machine, that is, magenta ink, cyan ink, yellow ink, and black ink. In recent years, light color inks including light magenta, light cyan, and light yellow have been developed for use in ink-jet printing, giving more plentiful color.

Most of these ink compositions use water-based dyes. The so-called water-based dye has superior water miscibility and inferior water-fastness. Thus, the printing image exhibits inferior water-fastness. Also, water-based dye has inferior light resistance. Thus, the printing image loses color intensity very easily and the image stability is poor.

Color can be specified by two systems: color appearance and color mixing. Color appearance system is obtained from collecting data of actual colored objects and systematically generalizing the data. Examples include the Ostwald color system, the Munsell color system, and the DIN color system. Color mixing system is based on the principle that primary color stimulus can be matched to generate various colors. Presently, the most important color mixing system is the CIE colorimetric system, which measures color instrumentally. For example, the Munsell color system was developed by Munsell, an American painter, and is the most famous system, describing color by hue, value, and chroma. For the CIE colorimetric system, the color stimulus (stimulus X, Y, and Z) and sensation of color are caused by the incorporation of light sources, objects, and observers. Color space is defined by three values L*, a*, and b*. L* indicates the lightness of a color, a* the hue, and b* the chroma of a color. a* ranges from -a (green) to +a (red), and b* ranges from −b (blue) to +b (yellow). In 1976, the CIE system further incorporated hue angle (h⁰) and chroma (C*) (see Formula 1 and 2). In the CIELAB color space, color difference (ΔE) indicates the color difference between two color samples (see Formula 3). The greater the ΔE, the greater the color difference between two color samples. OD (optical density), also represented by absorbency, is defined by Formula 4. After a light with intensity I₀ irradiates an object, the residual intensity is I.

h₀=tan⁻¹(b*/a*) Formula 1

C*=(a*²+b*²)^{1/2} Formula 2

ΔE(ΔL*²+Δa*²+Δb*²)^{1/2} Formula 3

OD=log (I₀/I) Formula 4

In the above Formula 3, the ΔE value is used to determine water-fastness. A smaller ΔE indicates that the ink composition fades color to a smaller extent after water washing and has better water-fastness.

### SUMMARY OF THE INVENTION

One object of the present invention is to provide a cyan dye set suitable for use in ink-jet printing.

Another object of the present invention is to provide a cyan ink-jet ink composition with superior water-fastness.

A further object of the present invention is to provide a color ink-jet ink composition including the above cyan ink.

To achieve the above-mentioned objects, the cyan dye set of the present invention includes Acid Blue 90 dye and at least one copper phthalocyanine type blue dye. The cyan dye set has better water-fastness when used in ink-jet ink. Therefore, the printing quality is enhanced.

The cyan ink-jet ink composition of the present invention includes Acid Blue 90 dye and at least one copper phthalocyanine type blue dye; and an aqueous solution medium. Additionally, the cyan ink-jet ink composition can further include at least one additive, such as an organic solvent, surfactant, pH buffer solution, chelating agent, biocide, humectant, preservative, or UV-blocker.

Moreover, the cyan ink-jet ink composition of the present invention can be mixed with any conventional magenta ink and yellow ink to form a color ink-jet ink.

### DETAILED DESCRIPTION OF THE INVENTION

The present invention mainly provides a cyan dye set with good water-fastness. The cyan dye set includes Acid Blue 90 dye and at least one copper phthalocyanine type blue dye. The copper phthalocyanine type blue dye is a copper complex and is frequently used as the main color in a cyan ink. The copper phthalocyanine type blue dye has the general formula given below:

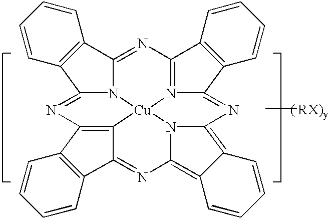

wherein RX represents a hydrophilic group such as an ionic group; and y is an integer of 1 to 6.

Copper phthalocyanine type blue dyes commonly used include Direct Blue 199 and Direct Blue 86 with the following formulae:

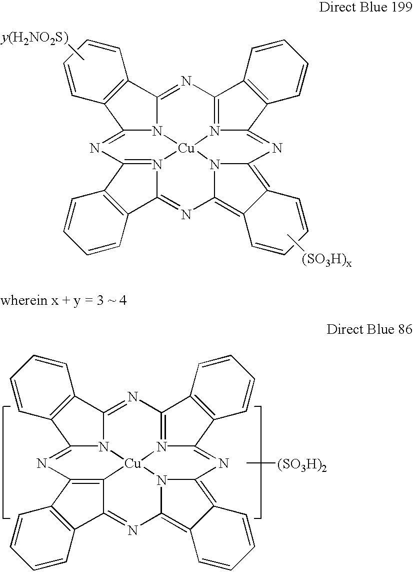

Of course, other copper phthalocyanine type blue dyes can also be used in the cyan dye set of the present invention.

In the ink composition of the present invention, preferally, each of the above dyes can be added in an amount of 0.1 to 10 weight %, most preferably 2 to 5 weight %, based on the total weight of the ink composition.

The ink composition of the present invention includes an aqueous solution medium. The aqueous solution medium is present in an amount of 50-95 weight %, preferably 70-90 weight %, and water is the main solvent. In addition to water, the aqueous solution medium can further include a water-soluble or water-miscible organic solvent, such as methanol, ethanol, ethylene glycol, diethylene glycol, triethylene glycol, polyethylene glycol, propylene glycol, butylene glycol, pentylene glycol, 2-propanol, di-1,2-propylene glycol, 2-pyrrolidone, N-methyl-2-pyrrolidone, 2,4,7,9-tetramethyl-5-decyne-4,7-diol, 1,1,1-trimethylolpropane, polyethylene glycol, polypropene glycol, EO/PO copolymers (ethylene oxide/propylene oxide copolymers), BO/EO copolymers (butylene oxide/ethylene oxide copolymers), hexylene glycol, or polyhydric alcohols. The organic solvent can be added in an amount of 0.1 to 20 weight %, preferably 1.0 to 15 weight %, based on the weight of the medium.

The ink composition of the present invention can further include one or more kinds of a surfactant added in an amount of 0.01 to 30 weight %, more preferably 0.01 to 3.0 weight %, based on the weight of the medium. The surfactant can be anionic, cationic, non-ionic, or zwitterionic. Representative examples of the suitable surfactants include sodium dioctyl sulfosuccinate, alkylene oxide adduct of acetylene glycol, polybutyl resin, cellulose derivatives, styrene/acrylic copolymer resin, maleic acid/styrene copolymer, or polymers containing both hydrophilic and hydrophobic segments.

Commercially available surfactants include Tergitol 15-S-9 from Union Carbide, A-102 from CYTEC, LF-4 from CYTEC, 1,3-BG from KYOWA, OG from KYOWA, BEPG from KYOWA, PD-9 from KYOWA, EP-810 from AIR PRODUCT, CT-141 from AIR PRODUCT, CT-151 from AIR PRODUCT, OT-75 from CYTEC, GPG from CYTEC, and OT-70PG from CYTEC.

The ink composition of the present invention can further include a humectant. The humectant is usually a low volatile liquid and is used to decrease evaporation. Also, the humectant has good miscibility with the main solution. The addition of the humectant can prevent the ink at the nozzle of the ink cartridge from evaporation and resultant precipitation and crystals, thus preventing plugging of the nozzle. Typical humectants used in the ink-jet ink can be polyethylene glycol, diethylene glycol, or glycerol, added in an amount of 0.1 to 30.0 weight %, preferably 2.0 to 15 weight %, based on the weight of the medium.

The ink composition of the present invention can further include a pH buffer solution. The colorant can create ideal colors only within a suitable pH range. The pH buffer solution suitable for use can be diethanolamine, triethanolamine, hydroxides of alkali metal such as lithium hydroxide, sodium hydroxide, and potassium hydroxide, ammonium hydroxide, and carbonates of alkali metals such as lithium carbonate, sodium carbonate, and potassium carbonates.

The ink composition of the present invention can further include a chelating agent. The addition of the chelating agent can prevent generation of crystalline salt. This prevents coagulation of particles and plugging of the nozzle of the ink cartridge. Chelating agents suitable for use include sodium ethylenediaminetetraacetate, trisodium nitrilotriacetate, hydroxyethyl ethylenediamine trisodium acetate, diethylenetriamino pentasodium acetate, and uramil disodium acetate.

In addition, the ink composition of the present invention can further include a UV-blocker to block the absorbance of the UV light and increase the light resistance of the colorant. A biocide or preservative can be added to inhibit the growth of microorganisms. A dispersant can be added to increase the dispersing ability of the additives in the ink.

The cyan ink-jet ink composition of the present invention can be mixed with any conventional magenta ink and yellow ink to obtain a color ink-jet ink. Suitable magenta dye used in magenta ink includes Reactive Red 180, Acid Red 52, and Acid Red 92. Suitable yellow dye used in yellow ink includes Acid Yellow 23, Direct Yellow 132, and Direct Yellow 86.

The cyan dye set of the present invention has good water-fastness when used in ink-jet printing and can enhance the printing quality.

The following examples are intended to illustrate the process and the advantages of the present invention more fully without limiting its scope, since numerous modifications and variations will be apparent to those skilled in the art.

### Example 1

The cyan ink composition of the example included 3 wt % of Direct Blue 199 from Bayer AG, 1.5 wt % of Acid Blue 90 from Orient Chemical, 3.0 wt % of surfactant Tergitol 15-S-9 from Union Carbide, 12.0 wt % of ethylene glycol from Aldrich, 79.7 wt % of water, 0.1 wt % of pH buffer MES (morpholinoethane sulfonic acid), 0.2 wt % of chelating agent EDTA, and 0.5 wt % of biocide Proxel GXL from ICI.

Water-fastness was measured by the following method. The cyan ink composition was printed on ordinary plain paper using an ink-jet printer and measured for color properties. The printed paper was then placed in deionized water for 30 minutes of washing, removed from washing, dried at room temperature, and measured for color properties again. The results for ΔE are shown in Table 1.

### Example 2

The cyan ink composition of this example included 3 wt % of Direct Blue 86 from Bayer AG, 1.5 wt % of Acid Blue 90 from Orient Chemical, 3.0 wt % of Tergitol 15-S-9 (surfactant) from Union Carbide, 12.0 wt % of ethylene glycol from Aldrich, 79.0 wt % of water, 0.1 wt % of MES (pH buffer), 0.2 wt % of EDTA (chelating agent), and 0.5 wt % of Proxel GXL (biocide) from ICI.

The printing and test methods were the same as described in Example 1.

### Example 3

The cyan ink composition of this example included 1.5 wt % of Direct Blue 199 from Bayer AG, 1.5 wt % of Acid Blue 9 from Orient Chemical, 1.5 wt % of Acid Blue 90 from Orient Chemical, 3.0 wt % of Tergitol 15-S-9 (surfactant) from Union Carbide, 12.0 wt % of ethylene glycol from Aldrich, 79.7 wt % of water, 0.1 wt % of MES (pH buffer), 0.2 wt % of EDTA (chelating agent), and 0.5 wt % of Proxel GXL (biocide) from ICI.

The printing and test methods were the same as described in Example 1.

### Comparative Example 1

The same procedures were employed as described in Example 1, except that Acid Blue 90 was replaced by Acid Blue 9 from Orient Chemical.

### Comparative Example 2

The same procedures were employed as described in Example 1, except that the ink used was changed to the cyan ink from ink cartridge of Hewlett-Packard C6578 color printer.

### Comparative Example 3

The same procedures were employed as described in Example 1, except that the ink used was changed to the cyan ink from ink cartridge of Lexmark 12A1980 color printer.

TABLE 1

| | Exam- | Exam- | Exam- | Comp. | Comp. | Comp. |
|---|---|---|---|---|---|---|
| | ple 1 | ple 2 | ple 3 | Example 1 | Example 2 | Example 3 |
| ΔE | 11.18 | 14.99 | 22.71 | 32.13 | 35.97 | 35.44 |

The ΔE value is used to determine water-fastness. A smaller ΔE indicates that the ink composition fades color to a smaller extent after water washing and has better water-fastness. It can be seen from Table 1 that the ink of Examples 1 to 3 (containing Acid Blue 90 and a copper phthalocyanine type blue dye) exhibits better water-fastness than conventional ink.

The foregoing description of the preferred embodiments of this invention has been presented for purposes of illustration and description. Obvious modifications or variations are possible in light of the above teaching. The embodiments chosen and described provide an excellent illustration of the principles of this invention and its practical application to thereby enable those skilled in the art to utilize the invention in various embodiments and with various modifications as are suited to the particular use contemplated. All such modifications and variations are within the scope of the present invention as determined by the appended claims when interpreted in accordance with the breadth to which they are fairly, legally, and equitably entitled.

What is claimed is:

1. A cyan dye set suitable for use in ink-jet printing, comprising:
Acid blue 90 dye; and
at least one copper phthalocyanine type blue dye.

2. A cyan ink-jet ink composition, comprising:
Acid Blue 90 dye and at least one copper phthalocyanine type blue dye; and
an aqueous solution medium.

3. The cyan ink-jet ink composition as claimed in claim 2, comprising 0.1 to 10 weight % of Acid Blue 90 dye and 0.1 to 10 weight % of a copper phthalocyanine type blue dye.

4. The cyan ink-jet ink composition as claimed in claim 2, wherein the copper phthalocyanine type blue dye is Direct Blue 199.

5. The cyan ink-jet ink composition as claimed in claim 2, wherein the copper phthalocyanine type blue dye is Direct Blue 86.

6. The cyan ink-jet ink composition as claimed in claim 2, wherein the aqueous solution medium is present in an amount of 50 to 95 weight %.

7. The cyan ink-jet ink composition as claimed in claim 2, wherein the aqueous solution medium includes at least one additive, and the additive is an organic solvent, surfactant, pH buffer solution, chelating agent, biocide, humectant, preservative, or UV-blocker.

8. The cyan ink-jet ink composition as claimed in claim 7, wherein the medium includes 0.1 to 20 weight % of an organic solvent.

9. The cyan ink-jet ink composition as claimed in claim 7, wherein the medium includes 0.01 to 30 weight % of a surfactant.

10. The cyan ink-jet ink composition as claimed in claim 7, wherein the medium includes 0.1 to 30 weight % of a humectant.

11. An ink-jet ink composition, comprising:
(1) a cyan ink including Acid Blue 90 dye, at least one copper phthalocyanine type blue dye, and an aqueous solution medium;
(2) a magenta ink; and
(3) a yellow ink.

12. The ink-jet ink composition as claimed in claim 11, wherein the cyan ink includes 0.1 to 10 weight % of Acid Blue 90 dye and 0.1 to 10 weight % of a copper phthalocyanine type blue dye.

13. The ink-jet ink composition as claimed in claim 11, wherein the copper phthalocyanine type blue dye is Direct Blue 199.

14. The ink-jet ink composition as claimed in claim 11, wherein the copper phthalocyanine type blue dye is Direct Blue 86.

15. The ink-jet ink composition as claimed in claim 11, wherein the aqueous solution medium is present in an amount of 50 to 95 weight %.

16. The ink-jet ink composition as claimed in claim 11, wherein the aqueous solution medium includes at least one additive, and the additive is an organic solvent, surfactant, pH buffer solution, chelating agent, biocide, humectant, preservative, or UV-blocker.

17. The ink-jet ink composition as claimed in claim 16, wherein the medium includes 0.1 to 20 weight % of an organic solvent.

18. The ink-jet ink composition as claimed in claim 16, wherein the medium includes 0.01 to 30 weight % of a surfactant.

19. The ink-jet ink composition as claimed in claim 16, wherein the medium includes 0.1 to 30 weight % of a humectant.
